(19) United States
(12) Patent Application Publication
(10) Pub. No.: US 2014/0085334 A1
(43) Pub. Date: Mar. 27, 2014

(54) Transparent Texting

(71) Applicant: APPLE INC., Cupertino, CA (US)

(72) Inventor: Stephen T. Payne, Waterford, MI (US)

(73) Assignee: Apple Inc., Cupertino, CA (US)

(21) Appl. No.: 13/627,959

(22) Filed: Sep. 26, 2012

(51) Int. Cl. G09G 5/377

(52) U.S. Cl. 345/633

(57) ABSTRACT

An electronic communication device's camera can continuously capture and present video images as a background within a text messaging session currently being displayed by the device. The camera can be a rear-facing camera on the device, so that the video images represent the views that the device's user would see if the device's display were transparent. The camera can continuously capture and present the video images as the background in the text messaging session, so that the device's user continuously can be aware of the environment beyond the device's display while still focusing on the text messages being communicated. The background within the text messaging session can continuously be a live and current video image of the view seen by the camera at any given moment. Consequently, the device's user is less likely to collide with or stumble over an object while participating in a text messaging session.

### BACKGROUND

The present disclosure relates generally to user interfaces, and in particular to a user interface that enables the viewing of camera-captured content during a text messaging session.

Computers and other electronic devices can communicate with each other over networks such as local area networks, wide area networks, and the Internet. Mobile devices such as cell phones, including so-called smart phones, can communicate with each other wirelessly over a variety of wireless networks including 3G and 4G networks. These electronic communication devices often can enable the users of those devices to communicate with each other by sending text messages over networks between those devices.

Typically, during a text messaging session, a user of one device will use a keyboard interface (potentially displayed on a touch-sensitive screen of that device) to enter a text message and then activate a control within a user interface to cause the device to transmit that text message over one or more networks toward the recipient device. The recipient device concordantly receives the text message through a network interface and displays the text message to the user of the recipient device through that device's user interface. That user can then use his device to enter and send another text message back to the other user's device using similar techniques. In this manner, two (or more) users conduct a text-based communication session with each other using their electronic communication devices.

If the electronic communication devices are mobile devices such as cell phones, then the text messages can be transmitted wirelessly between the devices using a text messaging protocol such as Short Messaging Protocol (SMS). Conventionally, if a device involved in such a text-based communication session is a mobile device, then the user interface of that mobile device presents, to the device's user, the most recently sent and received text messages. For example, a mobile device can display “text bubbles” that include a separate text bubble for each recent text message from the text messaging session. Each such text bubble can contain text from a separate message from the text messaging session. Messages received from other user's devices can be displayed in one color, and aligned on the left side of the device's display, while messages transmitted by the device's own user can be displayed in another color, and aligned on the right side of the device's display. In this manner, the display helps the device's user to distinguish between text messages that the user sent and text messages that the user received. As a text messaging session progresses, text bubbles containing less recently sent and received text messages can be scrolled upward on the device's display in order to make room for text bubbles containing more recently sent and received text messages at the lower portion of the display, until those upwardly-scrolled text bubbles eventually vanish from the top of the display.

Conventionally, during a text messaging session conducted using a mobile device, the text bubbles presented on the display are opaque and mono-colored. The background over which the text bubbles are rendered is also opaque and mono-colored. The text bubbles are presented in the foreground of the display, such that the text bubbles completely obscure the portions of the mono-colored background that exists behind the text bubbles.

Mobile device users who are currently engaged in a text messaging session can find themselves in a rather unique predicament. Because they are using mobile devices, those users often will be in motion. For example, it is common, even if not entirely safe, for a mobile device user to engage in a text messaging session while he is concurrently walking Due to the visual nature of a text messaging session, such a user often will find it difficult to divide his attention between his device's display and his environmental surroundings. A user who is walking while participating in a text messaging session may inadvertently collide with or stumble over objects in his path because his attention was focused on his device's display instead of the path that he was traversing. Even if a user remains stationary while participating in a text messaging session, that user may expose himself to some amount of danger or potential embarrassment if he is so engaged in his device's display that he becomes oblivious to changes in his surrounding environment.

### SUMMARY

Certain embodiments of the present invention can continuously capture video images using an electronic communication device's camera, and continuously present those video images as a background within a text messaging session currently being displayed by the device. The camera capturing the video images can be a rear-facing camera on the device, so that the video images represent the views that the device's user would see if the device's display were transparent. The camera can continuously capture and present the video images as the background in the text messaging session, so that the device's user continuously can be at least somewhat aware of the environment beyond the device's display while still focusing on the text messages being communicated. The background within the text messaging session can continuously be a live and current video image of the view seen by the camera at any given moment. Consequently, the device's user is less likely to collide with or stumble over an object while participating in a text messaging session.

In certain embodiments of the invention, the text bubbles containing the text messages can also be transparent or semi-transparent instead of opaque, so that the background video image is at least partially visible within the text bubbles. In such embodiments of the invention, the text itself may remain opaque so as to remain understandable even though it is overlaid over the background video image.

The following detailed description together with the accompanying drawings will provide a better understanding of the nature and advantages of the present invention.

### BRIEF DESCRIPTION

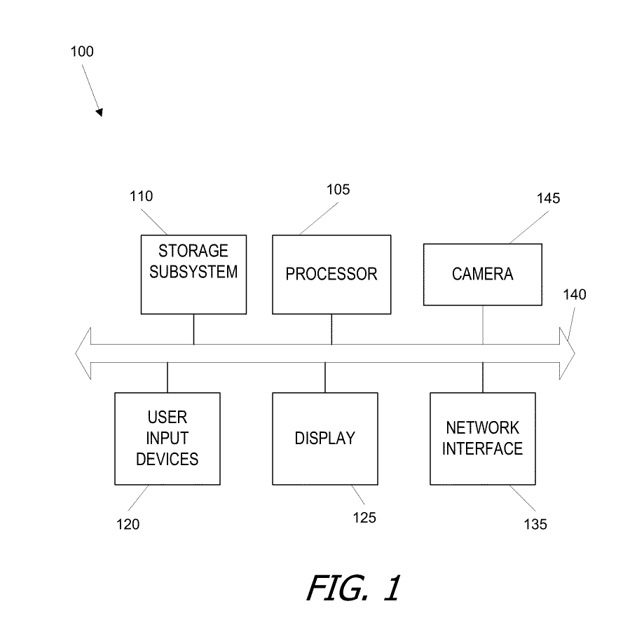

FIG. 1 is a block diagram of a computer system according to an embodiment of the present invention.

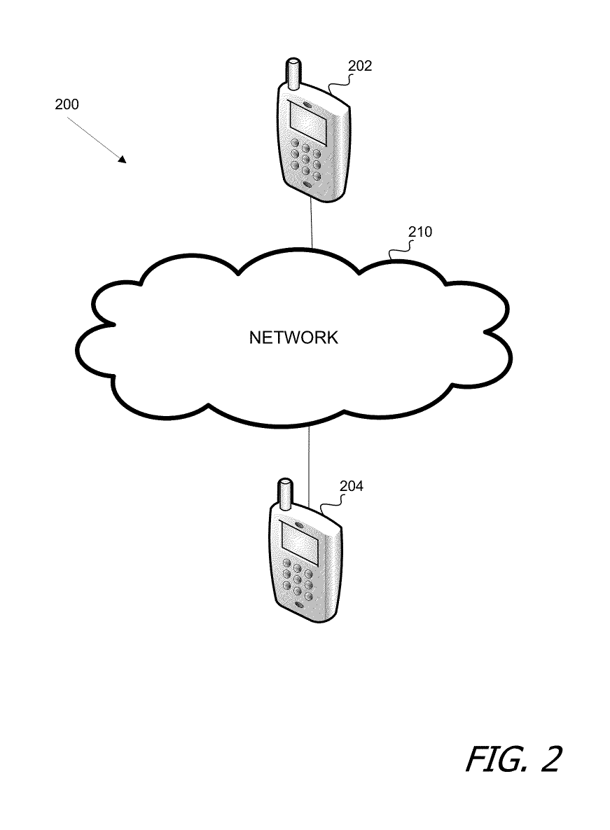

FIG. 2 is block diagram illustrating a system in which multiple smart phones can participate in a text messaging session with each other, according to an embodiment of the invention.

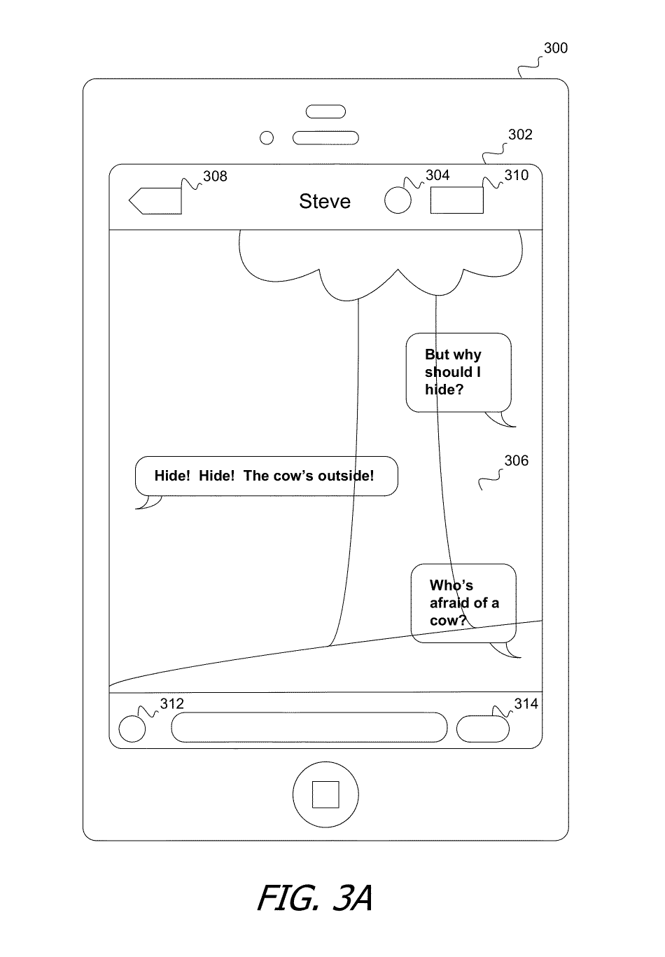

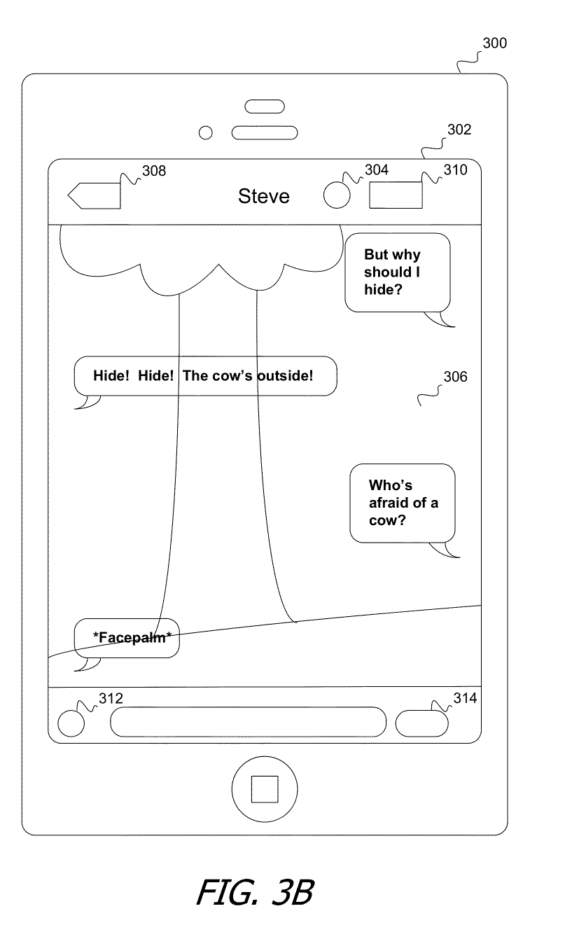

FIG. 3A is a block diagram illustrating a user interface that can present a video background image representing a current scene behind a smart phone within a text messaging session, according to an embodiment of the invention.

FIG. 3B is a block diagram illustrating the user interface of FIG. 3A at a later time after the background image has changed and an additional text message has been sent, according to an embodiment of the invention.

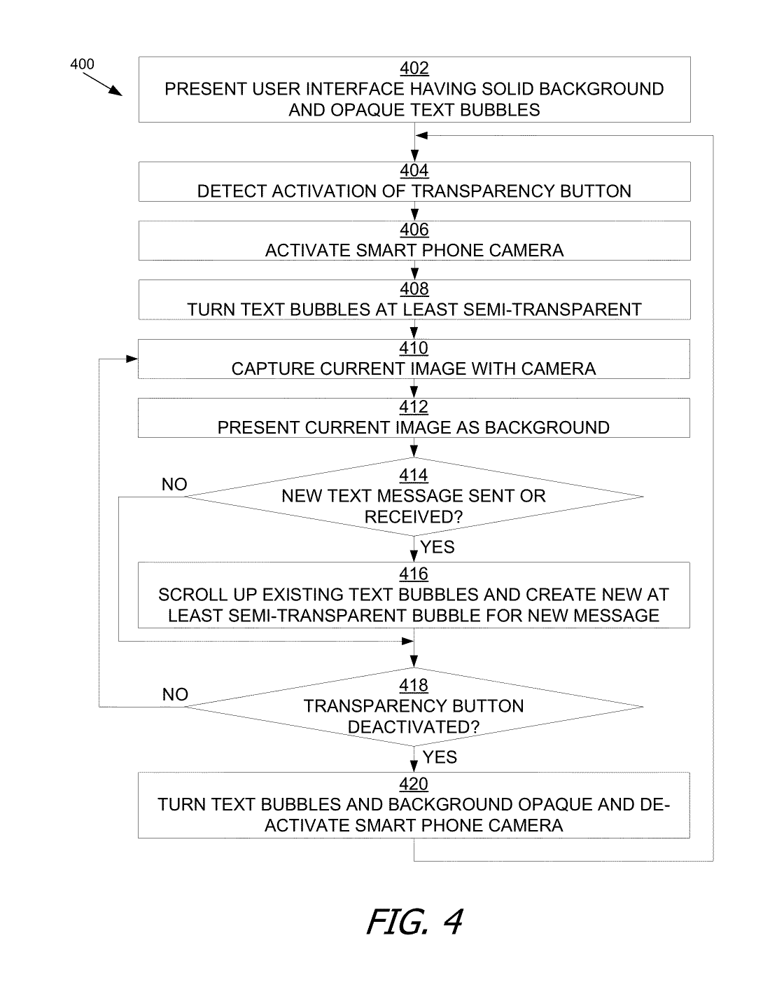

FIG. 4 is a flow diagram illustrating an example of a technique that can be performed in order to achieve transparent texting, according to an embodiment of the invention.

### DETAILED DESCRIPTION

FIG. 1 illustrates a computing system 100 according to an embodiment of the present invention. Computing system 100 can be implemented as any of various computing devices, including, e.g., a desktop or laptop computer, tablet computer, smart phone, personal data assistant (PDA), or any other type of computing device, not limited to any particular form factor. Computing system 100 can include processing unit(s) 105, storage subsystem 110, input devices 120, display 125, network interface 135, and bus 140. Computing system 100 can be an iPhone or an iPad.

Processing unit(s) 105 can include a single processor, which can have one or more cores, or multiple processors. In some embodiments, processing unit(s) 105 can include a general-purpose primary processor as well as one or more special-purpose co-processors such as graphics processors, digital signal processors, or the like. In some embodiments, some or all processing units 105 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 105 can execute instructions stored in storage subsystem 110.

Storage subsystem 110 can include various memory units such as a system memory, a read-only memory (ROM), and a permanent storage device. The ROM can store static data and instructions that are needed by processing unit(s) 105 and other modules of computing system 100. The permanent storage device can be a read-and-write memory device. This permanent storage device can be a non-volatile memory unit that stores instructions and data even when computing system 100 is powered down. Some embodiments of the invention can use a mass-storage device (such as a magnetic or optical disk or flash memory) as a permanent storage device. Other embodiments can use a removable storage device (e.g., a floppy disk, a flash drive) as a permanent storage device. The system memory can be a read-and-write memory device or a volatile read-and-write memory, such as dynamic random access memory. The system memory can store some or all of the instructions and data that the processor needs at runtime.

Storage subsystem 110 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 110 can include removable storage media that can be readable and/or writeable; examples of such media include compact disc (CD), read-only digital versatile disc (e.g., DVD-ROM, dual-layer DVD-ROM), read-only and recordable Blu-Ray® disks, ultra density optical disks, flash memory cards (e.g., SD cards, mini-SD cards, micro-SD cards, etc.), magnetic “floppy” disks, and so on. The computer readable storage media do not include carrier waves and transitory electronic signals passing wirelessly or over wired connections.

In some embodiments, storage subsystem 110 can store one or more software programs to be executed by processing unit(s) 105. “Software” refers generally to sequences of instructions that, when executed by processing unit(s) 105 cause computing system 100 to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 110, processing unit(s) 105 can retrieves program instructions to execute and data to process in order to execute various operations described herein.

A user interface can be provided by one or more user input devices 120, display device 125, and/or and one or more other user output devices (not shown). Input devices 120 can include any device via which a user can provide signals to computing system 100; computing system 100 can interpret the signals as indicative of particular user requests or information. In various embodiments, input devices 120 can include any or all of a keyboard, touch pad, touch screen, mouse or other pointing device, scroll wheel, click wheel, dial, button, switch, keypad, microphone, and so on.

Display 125 can display images generated by computing system 100 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). Some embodiments can include a device such as a touchscreen that function as both input and output device. In some embodiments, other user output devices can be provided in addition to or instead of display 125. Examples include indicator lights, speakers, tactile “display” devices, printers, and so on.

In some embodiments, the user interface can provide a graphical user interface, in which visible image elements in certain areas of display 125 are defined as active elements or control elements that the user can select using user input devices 120. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular array in display 125. Other user interfaces can also be implemented.

Network interface 135 can provide voice and/or data communication capability for computing system 100. In some embodiments, network interface 135 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments, network interface 135 can provide wired network connectivity (e.g., Ethernet) in addition to or instead of a wireless interface. Network interface 135 can be implemented using a combination of hardware (e.g., antennas, modulators/demodulators, encoders/decoders, and other analog and/or digital signal processing circuits) and software components.

Bus 140 can include various system, peripheral, and chipset buses that communicatively connect the numerous internal devices of computing system 100. For example, bus 140 can communicatively couple processing unit(s) 105 with storage subsystem 110. Bus 140 also connects to input devices 120 and display 125. Bus 140 also couples computing system 100 to a network through network interface 135. In this manner, computing system 100 can be a part of a network of multiple computer systems (e.g., a local area network (LAN), a wide area network (WAN), an Intranet, or a network of networks, such as the Internet. Any or all components of computing system 100 can be used in conjunction with the invention.

A camera 145 also can be coupled to bus 140. Camera 145 can be mounted on a side of computing system 100 that is on the opposite side of the mobile device as display 125. Camera 145 can be mounted on the “back” of such computing system 100. Thus, camera 145 can face in the opposite direction from display 125. Camera 145 can continuously capture video images of the scene that currently is visible behind computing system 100, from the perspective of the user that is looking at display 125. These images can be continuously presented on display 125 as a background within a text messaging session. Consequently, the user of computing system 100 participating within such a text messaging session can continuously view, on display 125, the scene on the opposite side of the computing system 100 as though computing system 100 were transparent.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing unit(s) 105 can provide various functionality for computing system 100. For example, processing unit(s) 105 can execute a text messaging application. In some embodiments, the text messaging application is a software-based process that can receive text messages to be shown on a local display such as display 125. In some embodiments, the text messaging application receives text messages through user input devices 120 and sends those text messages to other devices via network interface 135.

It will be appreciated that computing system 100 is illustrative and that variations and modifications are possible. Computing system 100 can have other capabilities not specifically described here (e.g., mobile phone, global positioning system (GPS), power management, one or more cameras, various connection ports for connecting external devices or accessories, etc.). Further, while computing system 100 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

### Text Messaging System

FIG. 2 is a block diagram illustrating a system 200 in which multiple smart phones can participate in a text messaging session with each other, according to an embodiment of the present invention. In the embodiment illustrated, system 200 includes a local smart phone 202 and a remote smart phone computer 204. Local smart phone 202 can communicate with remote smart phone 204 via a network 210, to which both remote computer 202 and local computer 204 can be communicatively connected via wired or (more typically) wireless connections. Network 210 can be or can include a local area network, a wide area network, and/or the Internet. Network 210 can be or can include 3G and/or 4G networks.

In one embodiment of the invention, text messaging applications can execute concurrently on local smart phone 202 and remote smart phone 204. These applications can communicate with each other over network 210 using the SMS protocol or other text messaging protocols. Through these communications, smart phones 202 and 204 can convey, to each other, text messages entered by the users of those smart phones.

In one embodiment of the invention, local smart phone 202 can generate a user interface that includes a video background image which, at any given moment, represents the scene that is currently being viewed by a camera mounted on local smart phone 202. This camera can be mounted on the side of smart phone 202 that is opposite of the side that displays the user interface. Local smart phone 202 can overlay this live video background with text bubbles containing text messages. Such text messages may include text messages sent by local smart phone 202 to remote smart phone 204 as well as text messages sent by remote smart phone 204 to local smart phone 202. The text bubbles can be transparent, such that the video background image is completely visible through the text bubbles, or semi-transparent, such that the video background image is only partially visible through the text bubbles. Such semi-transparency can be achieved by alternating opaque pixels of a text bubble with transparent pixels from the video background image in a checkered manner. In this way, local smart phone 202 provides a transparent texting user interface. An example of a transparent texting user interface is discussed in further detail below.

### Transparent Texting User Interface

FIG. 3A is a block diagram illustrating a user interface that can present a video background image representing a current scene behind a smart phone within a text messaging session, according to an embodiment of the invention. Smart phone 300 can include a user interface 302. User interface 302 can be presented on a touch-sensitive display through which smart phone 300 can receive user input. By touching various user interface elements shown within user interface 302, a user of smart phone 300 can cause a text messaging application executing on smart phone 300 to perform various operations corresponding to those user interface elements.

User interface 302 can include a transparency button 304. According to an embodiment of the invention, in response to a user's activation of transparency button 304, the text messaging application executing on smart phone 300 can cause a background 306 to change from a default solid gray background to a live video background. Live video background 306 can continuously displays an image that is currently being viewed by a camera located on the opposite side of smart phone 300 from user interface 302. Thus, the camera can view the scene behind smart phone 300 from the user's perspective, assuming that the user is facing user interface 302. Consequently, live video background 306 can give user interface 302 the appearance of being transparent, in that the user can be given the sensation of being able to “see through” user interface 302 to the other side of smart phone 300. As the scene being viewed by the camera changes over time, the text messaging application can continuously refresh live video background 306 to represent the changed scene. In one embodiment of the invention, a user's activation of transparency button 304 while live video background 306 is being displayed causes the text messaging application to toggle the background back to the default solid gray background.

In the embodiment illustrated, while live video background 306 is being displayed in user interface 302, the text bubbles overlaid on live video background 306 are also transparent, so that live video background 306 is visible through those text bubbles. However, in an alternative embodiment, the text bubbles can be semi-transparent or opaque while live video background 306 is being displayed. If the text bubbles are opaque, then the area occupied by the text bubbles can obscure the portions of live video background 306 that are overlaid by those text bubbles. In the embodiment illustrated, in which the text bubbles are transparent, the sky, tree, and ground being displayed as part of live video background 306 are visible through the area contained by the text bubbles, and only the outlines of the text bubbles and the text itself partially obscure any part of live video background 306.

According to an embodiment, user interface 302 includes a back button 308. When selected by a user, back button 308 can cause smart phone 300 to cease displaying the current text messaging session and begin displaying a list of stored text messaging sessions. According to an embodiment, user interface 302 includes an edit button 310. When selected by a user, edit button 310 can cause smart phone 300 to place icons next to each text bubble, providing the user with mechanisms to select individual text messages to be deleted or forward to a specified destination. According to an embodiment, user interface 302 includes a camera button 312. When selected by a user, camera button 312 can cause smart phone 300 to present a menu whereby the user can either take a photograph with a camera of smart phone 300 or select an already taken photograph from a photograph album stored on smart phone 300. Upon taking or selecting a photograph, the text messaging application can send the taken or selected photograph within a new text bubble to another user that is participating in the text messaging session. This text bubble can be opaque or semi-transparent, depending on the particular embodiment.

According to one embodiment, user interface 302 includes a send button 314. When selected by a user, send button 314 can cause the text messaging application to transmit text contents of a text entry window next to send button 314 over networks to the other user that is participating in the text messaging session. This selection also can cause the text messaging application to scroll up the existing text bubbles overlaid on live video background 306 and create a new text bubble containing the most recently sent text message at the bottom of user interface 302. In various embodiments, text to be transmitted can be placed within the text entry window either by the user's spoken interaction with voice recognition mechanism of smart phone 300 or by the user's manual interaction with a virtual keyboard temporarily displayed on user interface 302.

FIG. 3B is a block diagram illustrating the user interface of FIG. 3A at a later time after the background image has changed and an additional text message has been sent, according to an embodiment of the invention. All of the elements of FIG. 3A are also shown in FIG. 3B.

However, in FIG. 3B, the tree shown in live video background 306 has moved to the left, due to the user having turned the device, with its mounted camera, to the right. Furthermore, in FIG. 3B, an additional transparent text message has been sent and overlaid over the changed background, causing the previous text messages of the conversation to scroll upward over the background. The additional transparent text message appears at the bottom left of live video background 306.

### Example Operational Flow

FIG. 4 is a flow diagram illustrating an example of a technique 400 that can be performed in order to achieve transparent texting, according to an embodiment of the invention. Technique 400 can be performed by smart phone 300 of FIG. 3, for example. Although technique 400 includes various steps performed in a specific order, alternative embodiment of the invention may involve additional steps, or omit steps, or perform steps in a different order from that shown in FIG. 4

In step 402, a text messaging application presents a user interface having a solid gray background and opaque text bubbles. In step 404, the text messaging application detects that the user has activated a transparency button displayed in the user interface. In step 406, in response to detecting the activation of the transparency button, the text messaging application activates a camera of the smart phone on which the text messaging application executes. As is explained above, this camera can be a camera that points away from the user. In step 408, the text messaging application causes all text bubbles within the current text messaging session to become transparent or semi-transparent. In step 410, the activated camera captures a current image of a scene. In step 412, the text messaging application presents the current image as the background image for the current text messaging session, such that the background image is at least partially visible through the text bubbles.

In step 414, the text messaging application determines whether a new text message has been sent or received. If a new text message has been sent or received, then control passes to step 416. Otherwise, control passes to step 418. In step 416, in response to determining that a new text message has been sent or received, the text messaging application scrolls up the existing text bubbles overlaid on the background and creates a new transparent or semi-transparent text bubble, containing the newly sent or received text message, at the bottom of the user interface. Control passes to step 418.

In step 418, the text messaging application determines whether the transparency button has been de-activated. If the transparency button has been de-activated, then control passes to block 420. Otherwise, control passes back to block 410.

In step 420, in response to detecting that the transparency button has been de-activated, the text messaging application deactivates the camera, turns the text bubbles in the current text messaging session opaque, and changes the background of the text messaging session from the camera's current image to the default opaque gray background. Control passes back to block 404. Thus, technique 400 is a technique whereby a user of a smart phone can opt to have a text messaging application of the smart phone continuously refresh a background for a text messaging session with a live video image that is currently being viewed by the smart phone's camera. This feature can help the user to remain aware of his environment without requiring him to divert his attention away from the text messaging session in which he is engaged.

### Extensions and Alternatives

An embodiment of the invention discussed above involves transparent text messages being overlaid upon a live video background that is captured and displayed continuously by a mobile device's video camera. Such an embodiment of the invention involves a text messaging session. However, in alternative embodiments of the invention, the same concepts of transparent text and a live, changing background over which that text is overlaid can be used in applications other than text messaging applications. For example, in an alternative embodiment of the invention, an Internet browsing application, such as Apple Safari, similarly can present a live and continuously updated video background in place of the static background that usually would be presented as the background of a web page that the application was currently showing. Text of the web page can be overlaid upon the live video background. For another example, in another alternative embodiment of the invention, a digital book-reading application, such as Apple iBooks, similarly can present a live and continuously updated video background in place of the static background that usually would be presented as the background of a (otherwise typically white) digital book page that the application was currently showing. Text of the digital book page can be overlaid upon the live video background. Alternative embodiments of the invention can be applied to virtually any computer-executable application in which text is presented over a background.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof Further, while the embodiments described above can make reference to specific hardware and software components, those skilled in the art will appreciate that different combinations of hardware and/or software components can also be used and that particular operations described as being implemented in hardware might also be implemented in software or vice versa.

Computer programs incorporating various features of the present invention can be encoded and stored on various computer readable storage media; suitable media include magnetic disk or tape, optical storage media such as compact disk (CD) or DVD (digital versatile disk), flash memory, and other non-transitory media. Computer readable media encoded with the program code can be packaged with a compatible electronic device, or the program code can be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method of communicating, the method comprising:
displaying, on a display on a front of a device, a background depicting a scene currently being viewed by a camera on the device;
overlaying, on the background, a messaging application capable of sending and receiving messages, the messaging application occupying a first area of the background;
wherein portions of the background on which the messaging application is overlaid are visible.

2. The method of claim 1, further comprising:
continuously updating the background to represent the scene being viewed by the camera as the scene being viewed changes over time, while maintaining, overlaid on the background throughout that time, both (a) one or more first messages generated by a user of the device and (b) one or more second messages received by the device from another device.

3. The method of claim 1, wherein overlaying the messaging application comprises displaying, for each text message of a set of text messages, a separate text message container through which the background is at least partially apparent.

4. The method of claim 1, further comprising:
prior to displaying the background depicting the scene currently being viewed by the camera, displaying the messaging application without displaying said background; and
in response to detecting a selection of a user interface element, causing the background to depict the scene currently being viewed by a camera on the device, and causing a message container presented by the messaging application to change from being opaque to being at least partially transparent.

5. A mobile device comprising:
a camera;
a display;
a network interface; and
one or more processors that are configured to receive video images continuously from the camera and continuously present the video images as a changing background in a text messaging application that is configured to overlay the background with one or more text bubbles that contain text sent and received through the network interface.

6. The mobile device of claim 5, wherein the one or more processors are configured to overlay the background with one or more text bubbles through which the changing background is at least partially visible.

7. The mobile device of claim 5, wherein the display faces toward a first direction on a first side of the mobile device; wherein the camera faces toward a second direction on a second side of the mobile device; and wherein the first direction is opposite the second direction.

8. The mobile device of claim 5, wherein the one or more processors are configured to present, on the display, a user interface element which, when activated, causes the one or more text bubbles to change from opaque to transparent.

9. The mobile device of claim 5, wherein the one or more processors are configured to present, on the display, a user interface element which, when activated, causes the camera to activate and causes the background to change from a solid opaque background to a background that is continuously refreshed with video images from the camera.

10. A computer-readable memory storing instructions which, when executed by one or more processors, cause the one or more processors to perform:
capturing a first video image at a first time;
changing a background of a text messaging application to be the first video image;
capturing a second video image at a second time; and
changing the background of the text messaging application to be the second video image;
wherein the second video image differs from the first video image.

11. The computer-readable memory of claim 10, wherein the one or more processors perform said capturing said first video image, said capturing said second video image, said changing said background to be said first video image, and changing said background to be said second video image while maintaining one or more text bubbles overlaid over the background.

12. The computer-readable memory of claim 10, wherein the instructions, when executed by the one or more processors, further cause the one or more processors to perform:
as part of changing the background of the text messaging application to be the first video image, changing contents of one or more text bubbles in a current messaging session to contain portions of the first video image; and
as part of changing the background of the text messaging application to be the second video image, changing contents of one or more text bubbles in a current messaging session to contain portions of the first video image.

13. The computer-readable memory of claim 10, wherein the instructions, when executed by the one or more processors, further cause the one or more processors to perform:
presenting a transparency button in the text messaging application;
detecting that a user has activated the transparency button; and
in response to detecting that the user has activated the transparency button, changing the background of the text messaging application from a solid opaque background to the first image.

14. The computer-readable memory of claim 10, wherein the instructions, when executed by the one or more processors, further cause the one or more processors to perform:
detecting that a new text message has been entered by a user of the text messaging application; and
in response to detecting that the new text message has been entered by the user of the text messaging application, presenting a text bubble that contains text of the new text message and through which the first and second images are at least partially visible.

15. The computer-readable memory of claim 10, wherein the instructions, when executed by the one or more processors, further cause the one or more processors to perform:
detecting that a new text message has been received over a wireless network; and
in response to detecting that the new text message has been received over the wireless network, presenting a text bubble that contains text of the new text message and through which the first and second images are at least partially visible.

16. A computer-readable memory storing instructions which, when executed by one or more processors, cause the one or more processors to perform:
during a text messaging session being conducted via a device, presenting, within the text messaging session, first information indicative of a visual environment of a user of the device;
during the text messaging session, determining that the visual environment of the user has changed since the first information was presented within the text messaging session; and
in response to determining that the visual environment of the user has changed since the first information was presented within the text messaging session, presenting, within the text messaging session, second information indicative of a change in the visual environment of the user of the device.

17. The computer-readable memory of claim 16, wherein the presenting the second information comprises replacing the first information with the second information in the text messaging session.

18. The computer-readable memory of claim 16, wherein the instructions, when executed by the one or more processors, further cause the one or more processors to perform:
while presenting the first information and the second information, maintaining, within the text messaging session, one or more displayed text messages, without changing contents of the one or more displayed text messages.

19. The computer-readable memory of claim 16, wherein determining that the visual environment has changed comprises recording an image of the visual environment through a camera mounted on a mobile device.

20. The computer-readable memory of claim 16, wherein said presenting the first information comprises displaying, visually behind one or more text bubbles of the text messaging session, a first scene that is visible to a camera at a first time; and wherein said presenting the second information comprises displaying, visually behind the one or more text bubbles of the text messaging session, a second scene that is visible to the camera at a second time; wherein the first scene differs from the second scene.

21. A computer-readable memory storing instructions which, when executed by one or more processors, cause the one or more processors to perform:
a device continuously recording video images over time; and
during the time, the device continuously refreshing a background of a text messaging application based on the video images while concurrently scrolling up text bubbles overlaid on the background whenever a new text message is sent or received by the text messaging application.

21. The computer-readable memory of claim 21, wherein the instructions, when executed by the one or more processors, further cause the one or more processors to perform:
while scrolling up the text bubbles, scrolling up the text bubbles while maintaining the continuous refreshing of the background with the video images being continuously recorded by the device.

22. The computer-readable memory of claim 21, wherein the continuous refreshing of the background of the text messaging session causes a visual effect of apparently allowing a user to see through a mobile device on which the text messaging session is being conducted.

23. The computer-readable memory of claim 21, wherein the instructions, when executed by the one or more processors, further cause the one or more processors to perform:
causing the background to change from an unchanging background to a continuously changing background in response to input received by a participant in the text messaging session.
